(19) United States
(12) Patent Application Publication
(10) Pub. No.: US 2013/0155594 A1
(43) Pub. Date: Jun. 20, 2013

(54) NOTEBOOK COMPUTER WITH CARD STORAGE STRUCTURE

(71) Applicant: PAO-CHING WANG, Tu-Cheng (TW)

(72) Inventor: PAO-CHING WANG, Tu-Cheng (TW)

(73) Assignee: HON HAI PRECISION INDUSTRY CO., LTD., Tu-Cheng (TW)

(21) Appl. No.: 13/535,285

(22) Filed: Jun. 27, 2012

(30) Foreign Application Priority Data
Dec. 19, 2011 (TW) 100147232

(51) Int. Cl. G06F 1/16

(52) U.S. Cl. 361/679.09; 361/679.02

(57) ABSTRACT

A notebook computer includes a case and top cover. The case includes a keyboard module, a placement member, and a plate cover. The top cover is pivotably mounted on the case. The top cover includes a screen. The placement member has an integral configuration. The placement member includes at least one audio mesh for audio output. A storage slot is defined in the placement member. The plate cover covers the storage slot.

### BACKGROUND

1. Technical Field

The disclosure generally relates to notebook computers, specifically to a notebook computer with a structure for storage cards.

2. Description of Related Art

On occasion, different storage cards, such as USB storage, SIM card, are used to store document files, photos, or movies when working with a notebook computer. However, these cards may not be well placed in the notebook computer after being used. Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a notebook computer in one embodiment.

FIG. 2 is an assembled view of the notebook computer of FIG. 1.

FIG. 3 is a partially assembled view of the notebook computer, shown with a plate cover in an open state in one embodiment.

FIG. 4 is an exploded, isometric view of a notebook computer in another embodiment.

FIG. 5 is an assembled view of the notebook computer of FIG. 4.

FIG. 6 is similar to FIG. 5, two sub-covers shown an open state.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

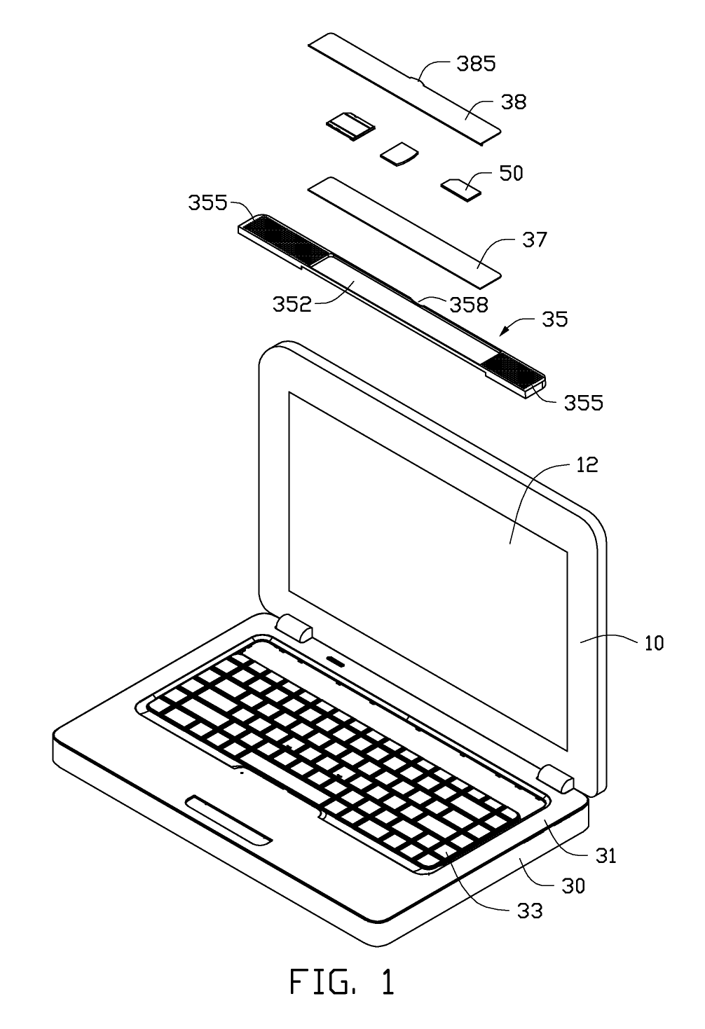

FIG. 1, is one embodiment, of a notebook computer. The notebook computer includes a case 30 and a top cover 10. The top cover 10 is pivotably mounted on the case 30. The top cover 10 includes a screen 12. The top cover 10 can cover the case 30.

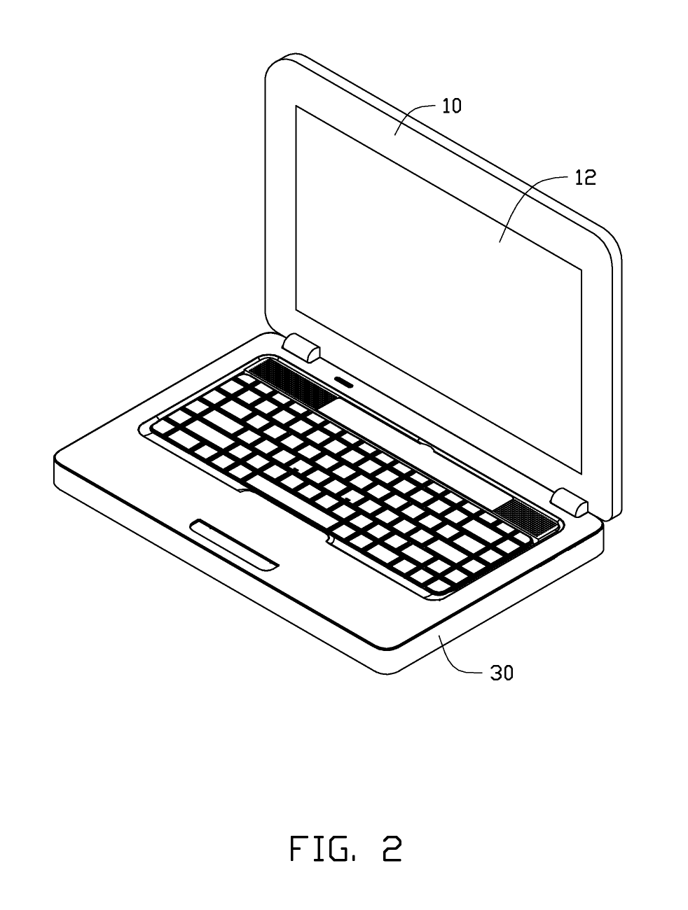

FIG. 2, illustrates one embodiment, of the case 30. The case 30 includes a body 31, a keyboard module 33, a placement member 35, a gasket 37, and a plate cover 38. The keyboard 33 is located on the body 31. The placement member 35 is located on a side of the keyboard module 33 to store a plurality of storage cards 50.

The body 31 can receive hardware, such as CPU, memory, or motherboard. The placement member 35 can be integrally formed. The placement member 35 is rectangular. A length of the placement member 35 is substantially equal to a length of the keyboard module 33. The placement member 35 includes two audio meshes 355 and defines a storage slot 352. The storage slot 352 is located between the two audio meshes 355. A speaker may be located under each of the audio meshes 355. Audio can transmit through the audio meshes 355. The two audio meshes 355 can respectively output two sound channels of an audio file. A recess 358 is defined in an edge of the placement member 35 adjacent to the storage slot 352.

The storage slot 352 is lower than a top surface of the each of the two audio meshes 355. The placement member 35 can be sound insulation except for the audio meshes 355.

The gasket 37 can be rectangular. The gasket 37 can be made of rubber. The gasket 37 located in the storage slot 352 can prevent sound vibrations caused by the audio.

In one embodiment, the plate cover 38 is rectangular. The plate cover 38 can be pivotably mounted on the placement member 35 to cover the storage slot 352. A tab 385 is located on a free edge of the plate cover 38 configured for facilitating the opening of the plate cover 38. The plate cover 38 can be flush with the top surface of each of the two audio meshes 355 when the plate cover 38 covers the storage slot 352.

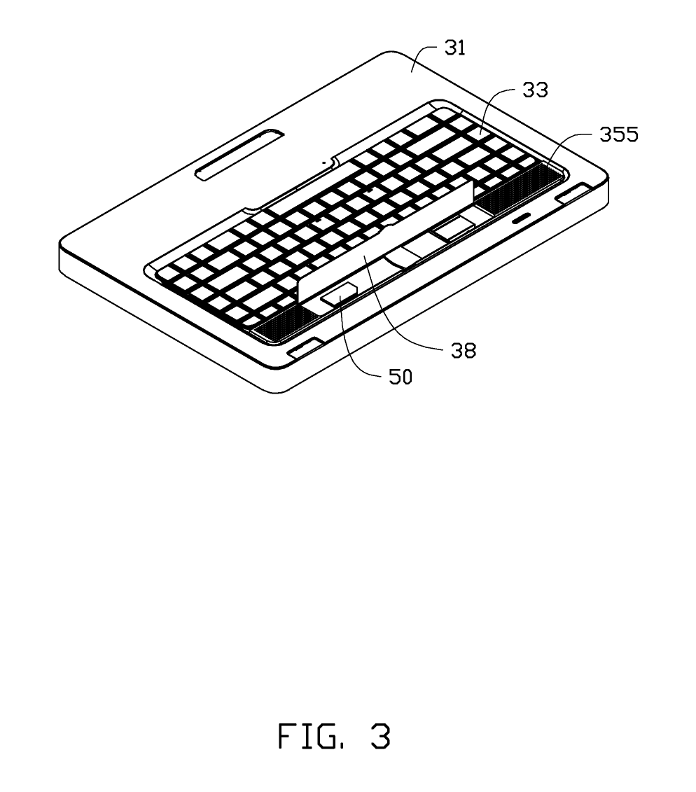

Referring to FIG. 3, in assembly, the top cover 10 is pivotably mounted on the case 30. The keyboard module 33 and the placement member 35 are mounted on the body 31. The placement member 35 is located between the keyboard module 33 and a joint of the top cover 10. The gasket 37 is located on the storage slot 352. The plate cover 38 is pivotably mounted on the placement member 35. The tab 385 is located away from the keyboard module 33. The plate cover 38 can be opened, and the storage slot 352 can be used to store the plurality of storage cards 50.

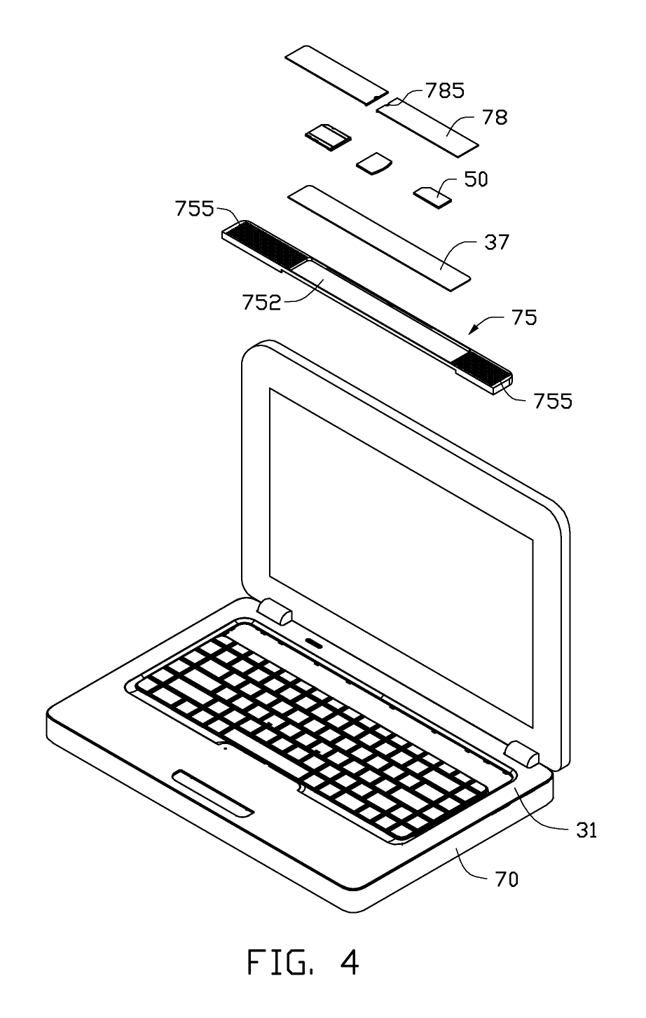

FIG. 4, illustrates another embodiment of the notebook computer. The notebook computer includes a case 70. The case 70 includes a placement member 75 and two sub-covers 78. The placement member 75 includes two audio meshes 755 and defines a storage slot 752. The two sub-covers 78 are slid in the placement member 75 to cover the storage slot 752 cooperatively. A tab 785 is located on each of the two sub-covers 78.

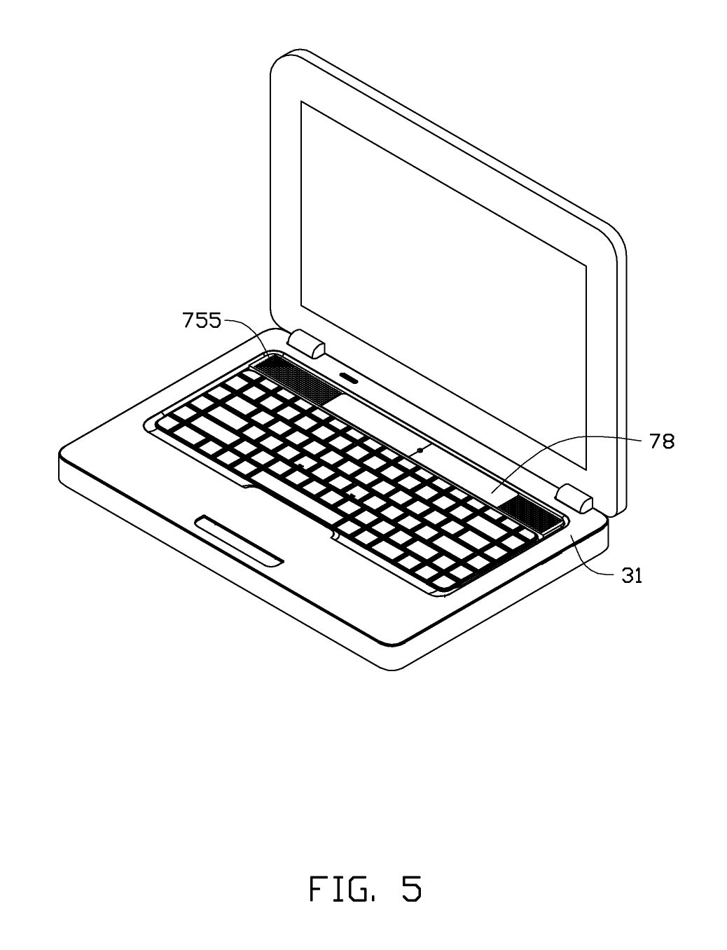

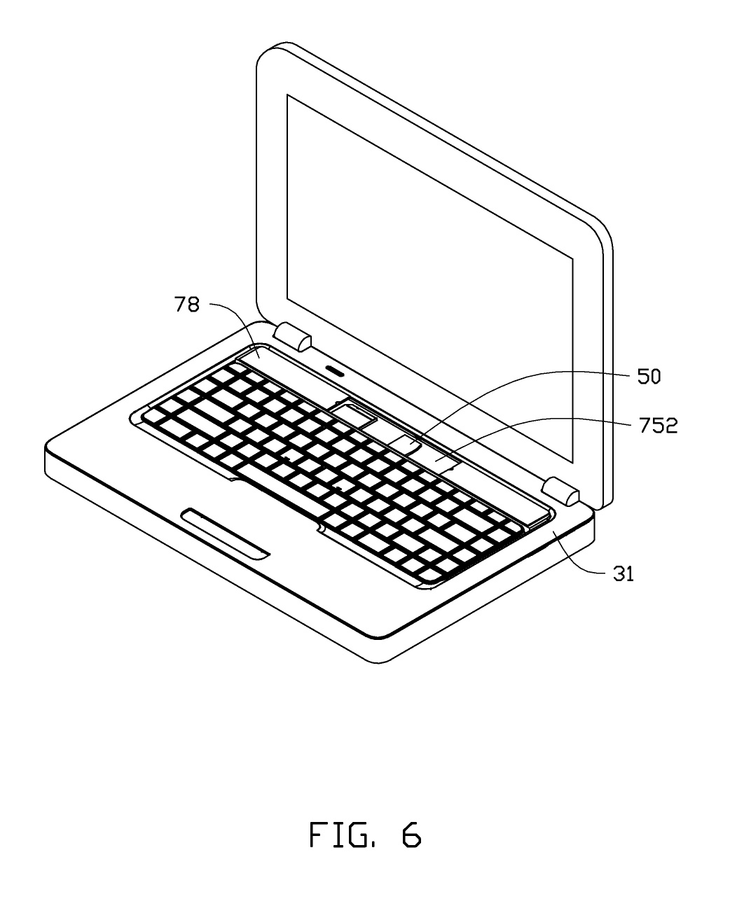

Referring to FIG. 5 and FIG. 6, in use, the two sub-covers 78 can slide on the placement member 75 to open or close the storage slot 752. The two sub-covers 78 may be soundproof. When the two sub-covers 78 are in an open position, the two sub-covers 78 can cover the two audio meshes 755 to shield audio from the two audio meshes 755. In an alternative embodiment, one of the two sub-covers 78 can slide to cover one of the two audio meshes 755 to shield one sound channel of the audio. The two sub-covers 78 may be located higher than a top surface of the two audio meshes 755.

It is also understood, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A notebook computer comprising:
a case comprising a keyboard module, a placement member, and a plate cover; and
a top cover pivotably mounted on the case, the top cover comprising a screen,
wherein the placement member has an integral configuration, the placement member comprises at least one audio mesh for audio output, a storage slot is defined in the placement member, and the plate cover covers the storage slot.

2. The notebook computer of claim 1, wherein the plate cover is pivotably mounted on the placement member.

3. The notebook computer of claim 2, wherein a tab is located on a free edge of the plate cover, and the tab is located away from the keyboard module.

4. The notebook computer of claim 2, wherein a recess is defined in the placement member away from the keyboard module.

5. The notebook computer of claim 1, wherein the at least one audio mesh comprises two audio meshes, and the storage slot is located between the two audio meshes.

6. The notebook computer of claim 5, wherein the storage slot is rectangular, and storage slot is lower than the two audio meshes.

7. The notebook computer of claim 6, wherein the plate cover comprises two sub-covers, and the two sub-covers are adapted to slide relative to the placement member.

8. The notebook computer of claim 7, wherein the two sub-covers covers the two audio meshes when the storage slot is opened.

9. The notebook computer of claim 1, wherein a length of the placement member is substantially equals to a length of the keyboard module.

10. The notebook computer of claim 1, wherein the case further comprises a rubber gasket located in the storage slot.

11. A computer comprising:
a case comprising a placement member and a plate cover;
wherein the placement member has an integral configuration, the placement member comprises at least one audio mesh for audio output, a storage slot is defined in the placement member, and the plate cover is movable from a first position to a second position, and the plate cover covers the storage slot in the first position, and the plate cover covers the at least one audio mesh in a second position.

12. The computer of claim 11, wherein the at least one audio mesh comprises two audio meshes, and the storage slot is located between the two audio meshes.

13. The computer of claim 12, wherein the storage slot is rectangular, and storage slot is lower than the two audio meshes.

14. The computer of claim 13, wherein the plate cover comprises two sub-covers, and the two sub-covers are adapted to slide relative to the placement member.

15. The computer of claim 14, wherein the two sub-covers covers the two audio meshes in the second position.

16. The computer of claim 11, wherein the case further comprises a rubber gasket located in the storage slot.
